(19) United States
(12) Patent Application Publication
(10) Pub. No.: US 2008/0049772 A1
(43) Pub. Date: Feb. 28, 2008

(54) Method of managing multiple traffic flows

(76) Inventors: Antonella Faniuolo, Swindon (GB); Sudeep Kumar Palat, Grange Park (GB); Anil M. Rao, Cedar Knolls, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/507,901

(22) Filed: Aug. 22, 2006

(51) Int. Cl. H04Q 7/00

(52) U.S. Cl. 370/412; 370/329

(57) ABSTRACT

Disclosed is a method of transmitting data from a plurality of traffic flows based on a quality of service indicator which indicates a manner of partitioning a rate grant such that more than one traffic flow, if desired, may simultaneously use the rate grant thereby avoiding rate grant starvation by one or more traffic flows. The method of transmitting data from a plurality of traffic flows comprises the steps of extracting data from one or more buffers based on the quality of service indicator and the rate grant, and transmitting a block of data comprising the extracted data wherein the one or more buffers are associated with one or more traffic flows.

### FIELD OF THE INVENTION

The present invention relates generally to wireless communication systems and, in particular, to a scheduled packet data system.

### BACKGROUND OF THE RELATED ART

As the Third Generation Partnership Project (3GPP) evolve Universal Mobile Telecommunication System (UMTS) to a pure packet data system, a single User Equipment (UE) will be able to simultaneously support multiple traffic flows (or radio bearers) associated with various applications, such as Voice over Internet Protocol (VoIP), Video Telephony (VT) and file transfers in accordance with a File Transfer Protocol (FTP). Each application may require varying degrees of quality of service (QoS). One manner of varying the degrees of QoS is to prioritize the traffic flows (or radio bearers) such that data from higher priority traffic flows are transmitted before data from lower priority traffic flows.

Release 6 of UMTS utilizes a scheduling mechanism which prioritizes traffic flows (i.e., priority order) and schedules the transmission thereof based on the associated priority order and a rate which has been granted (also referred to herein as a “rate grant”) to the UE, wherein the rate grant corresponds to a maximum block size allocated to the UE for transmission of its data, i.e., traffic flows. The UE will first attempt to use the entire rate grant to extract data from the buffer associated with the highest priority traffic flow, i.e., highest priority buffer. If there is no data in such buffer, or if any part of the allocated rate grant is unused (i.e., rate grant is larger than the amount of data in the highest priority buffer), then the UE will extract data from the buffer associated with the next highest priority traffic flow, and so on. The extracted data are subsequently multiplexed into a data packet and transmitted.

For example, suppose the UE is simultaneously supporting a VoIP application, a VT application and a FTP application. The traffic flows associated therewith may be prioritized based on time sensitiveness of the traffic flows, from highest to lowest, as follows: VoIP, VT and FTP. If the rate grant is 300 bits, then up to 300 bits may be extracted from the VoIP buffer (i.e., buffer associated with VoIP traffic flow), which is the highest priority traffic flow. If there is only 200 bits in the VoIP buffer, then up to 100 bits may be extracted from the VT buffer (i.e., buffer associated with VT traffic flow), which is the next highest priority traffic flow. If there is only 50 bits in the VT buffer, then up to 50 bits may be extracted from the FTP buffer (i.e., buffer associated with FTP traffic flow). The extracted 200 VoIP bits, 50 VT bits and 50 FTP bits are then multiplexed into a data packet and transmitted.

One problem with this scheduling mechanism is that the higher priority traffic flows may dominate the rate grant and lower priority traffic flows may be “rate grant starved” in the sense that the lower priority traffic flows gets little or none of the rate grant. A prior art proposal suggested reprioritizing the traffic flows in order to alleviate this problem. For example, the traffic flows described earlier may be reprioritized (from the original priority order of VoIP, VT and FTP) based on how much data are in the buffers to a new priority order of FTP, VoIP and VT (from highest to lowest). This proposal, however, may require the priorities to be switched back and forth quickly between the original priority order (e.g., VoIP, VT and FTP) and the new priority order (e.g., FTP, VoIP and VT) otherwise the lower priority traffic flows in the new priority order, e.g., VoIP, may be rate grant starved. Accordingly, there exists a method for managing multiple traffic flows such that traffic flows are not unnecessarily rate grant starved.

### SUMMARY OF THE INVENTION

An embodiment of the present invention is a method of transmitting data from a plurality of traffic flows based on a quality of service indicator which indicates a manner of partitioning a rate grant such that more than one traffic flow, if desired, may simultaneously use the rate grant thereby avoiding rate grant starvation by one or more traffic flows. In one embodiment, the method of transmitting data from a plurality of traffic flows comprises the steps of extracting data from one or more buffers based on the quality of service indicator and the rate grant, and transmitting a block of data comprising the extracted data wherein the one or more buffers are associated with one or more traffic flows.

### BRIEF DESCRIPTION OF THE DRAWINGS

The features, aspects, and advantages of the present invention will become better understood with regard to the following description, appended claims, and accompanying drawings where:

FIG. 1 depicts a wireless communication system used in accordance with one embodiment of the present invention;

FIG. 2 depicts a detailed block diagram illustrating an eNode B and a UE used in accordance with one embodiment of the present invention;

FIG. 3 depicts a flowchart illustrating the transmission of a plurality of traffic flows in accordance with an embodiment of the present invention; and

FIG. 4 depicts a sample lookup table which may be used partition rate grants for each of a VoIP, VT and FTP traffic flow or radio bearer.

### DETAILED DESCRIPTION

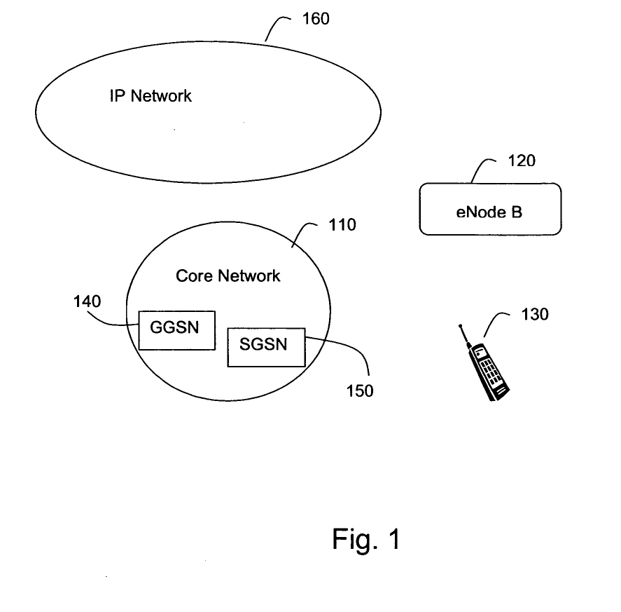

For purposes of discussion, an embodiment of the present invention will be described herein with respect to FIG. 1, which depicts a wireless communication system 100 based on the Long Term Evolution (LTE) of the well-known Universal Mobile Telecommunication System (UMTS) standard specification, i.e., packet data system. Wireless communication system 100 comprises a Core Network (CN) 110, an enhanced Node B (eNode B) 120 and a plurality of User Equipments (UE) 130. CN 110 comprises a Gateway GPRS Support Node (GGSN) 140 for interfacing with an Internet Protocol (IP) network 160 and a Serving GPRS Support Node 150 for interfacing with eNode B 120.

eNode B 120, also known as a Radio Access Network, serves the plurality of UE 130 using an Orthogonal Frequency Division Multiple Access (OFDMA) air interface. The OFDMA air interface comprises a plurality of orthogonal subcarrier frequencies which are partitioned in terms of frequency and/or time into reverse link and forward link resources. Reverse link resources are managed and assigned to UE 130 by a scheduler at eNode B 120. Reverse link assignments are indicated to UE 130 in scheduling grants transmitted over a control channel, such as a grant channel. The scheduling grant includes, among other things, identities of assigned subcarrier frequencies and a rate grant indicating a block size allocated to UE 130 for transmission of its data, i.e., traffic flows.

UE 130 utilizes the assigned reverse link resources to transmit its data to eNode B 120. The data is encapsulated into a Medium Access Control (MAC) packet (or other type of packet) before being transmitted from UE 130 to eNode B 120, wherein the size of the MAC packet is not larger than the rate grant. In an embodiment, the MAC packet may include data from one or more traffic flows or radio bearers, wherein each traffic flow or radio bearer is associated with a data application, such as Voice over Internet Protocol (VoIP), Video Telephony (VT) or file transfers in accordance with a File Transfer Protocol (FTP). The amounts of data included in the MAC packet from each traffic flow is determined in accordance with the rate grant, a Quality of Service (QoS) indicator and/or a priority order, wherein the QoS indicator indicates a manner of partitioning the rate grant for each of the traffic flows or radio bearers and the priority order indicates a priority level associated with each of the traffic flows.

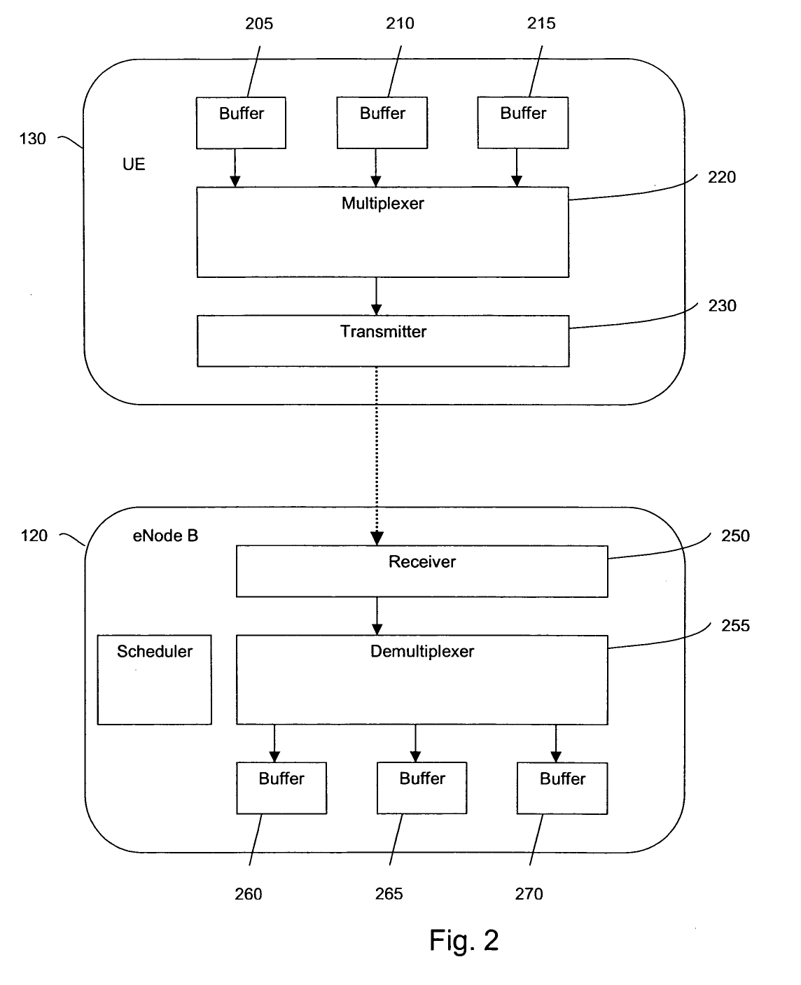

FIG. 2 depicts a block diagram 200 illustrating some of the functional elements of eNode B 120 and UE 130 in accordance with one embodiment of the present invention. UE 130 comprises a plurality of buffers 205, 210 and 215 for storing data associated with a plurality of traffic flows or radio bearers, a multiplexer 220 for multiplexing data from the plurality of buffers 205, 210 and 215 into a MAC packet, and a transmitter 230 for transmitting the MAC packet over an air interface. eNode B 120 comprises a receiver 250 for receiving the MAC packet over the air interface, a demultiplexer 255 for demultiplexing data from the received MAC packet, and a plurality of buffers 260, 265 and 270 for storing the demultiplexed data. eNode B 120 further comprises a scheduler for managing and assigning reverse link resources, such as assigning subcarrier frequencies, determining rate grants and generating QoS indicators.

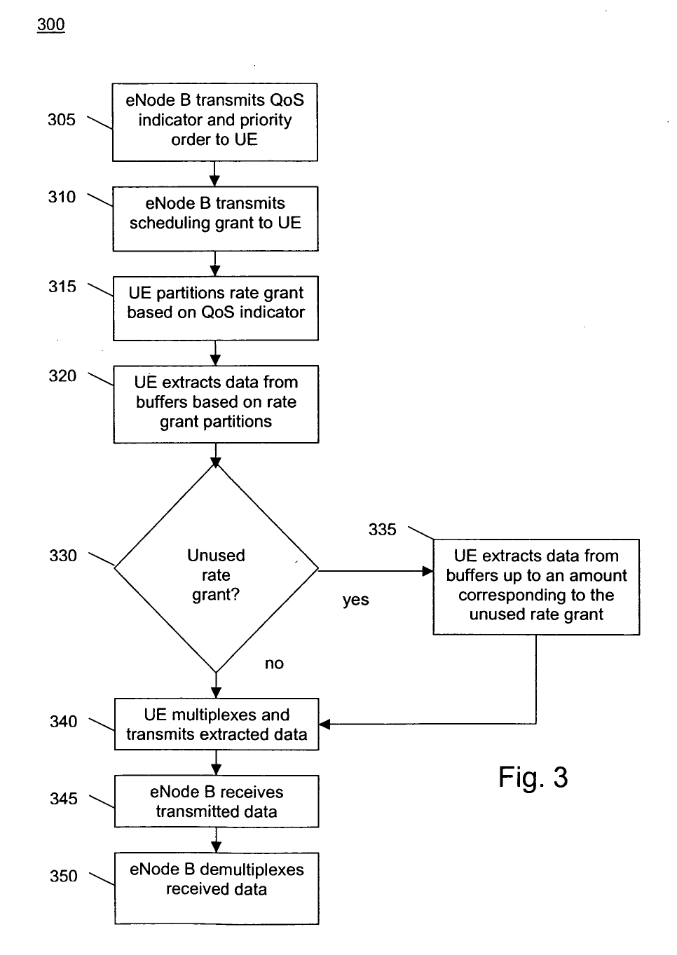

FIG. 3 depicts a flowchart 300 illustrating a manner of transmitting data from a plurality of traffic flows in accordance with an embodiment of the present invention. In step 305, a QoS indicator and a priority order are transmitted from eNode B 120 to UE 130 over a control channel. In another embodiment, the QoS indicator may be included in a scheduling grant or a MAC layer message, which may include only control information.

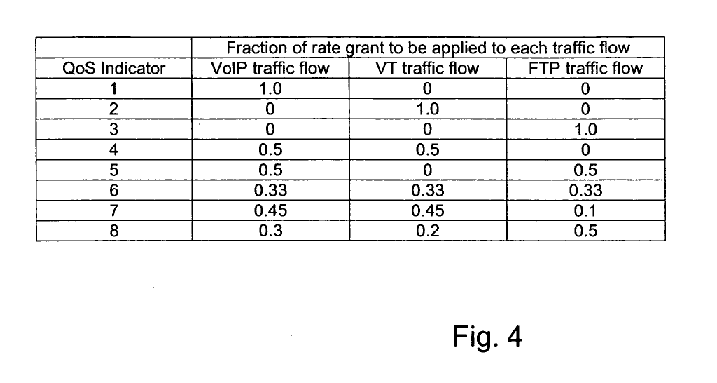

In one embodiment, the QoS indicator is an index to a lookup table at UE 130 mapping the index to a manner of partitioning the rate grant for each of the traffic flows or radio bearers. FIG. 4 depicts a sample lookup table 400 at UE 130 (and eNode B 120) which may be used partition rate grants for each of a VoIP, VT and FTP traffic flow or radio bearer at UE 130. A QoS of 8 indicates, for example, to partition the rate grant such that 30%, 20% and 50% of the rate grant are allocated to the VoIP, VT and FTP traffic flows, respectively.

In step 310, eNode B 120 transmits a scheduling grant to UE 130 over a control channel, such as a grant channel. In one embodiment, the scheduling grant comprises a rate grant, a bandwidth allocation and a modulation scheme. For example, the rate grant may indicate a block size of 1,000 bits, the bandwidth allocation may indicate the identity of 50 subcarrier frequencies, and the modulation scheme may indicate Quadrature Phase Shift Keying (QPSK). In another embodiment, the rate grant further comprises the QoS indicator and/or priority order.

In step 315, UE 130 receives the scheduling grant and partitions the rate grant (indicated by the scheduling grant) based on the QoS indicator. For example, for a rate grant of 1,000 bits and a QoS indicator of 8 (see FIG. 4), the rate grant would be partitioned (into rate grant partitions) as follows: 300 bits (i.e., 30% of 1000) would be allocated to the VoIP traffic flow, 200 bits (i.e., 20% of 1000) would be allocated to the VT traffic flow and 500 bits (i.e., 50% of 1000) would be allocated to the FTP traffic flow.

In step 320, multiplexer 220 extracts data from each of the plurality of buffers 205, 210 and 215 in accordance with the rate grant partitions. For example, multiplexer 220 extracts 300 bits from the buffer associated with the VoIP traffic flow (i.e., VoIP buffer), 200 bits from the buffer associated with the VT traffic flow (i.e., VT buffer), and 500 bits associated with the FTP traffic flow (i.e., FTP buffer).

In step 330, UE 130 (or multiplexer 220) determines whether the total rate grant is utilized. In one embodiment, UE 130 determines whether the total rate grant is utilized by checking if any of the rate grant partitions is unused. For example, suppose multiplexer 220 was able to extract 200, 200 and 500 bits from the VoIP, VT and FTP buffers, respectively. If 300, 200 and 500 bits are the rate grant partitions for the VoIP, VT and FTP traffic flows, respectively, then it would be determined 100 total bits of the rate grant (i.e., 100 bits of the rate grant partitioned for the VoIP traffic flow) are unused.

If the total rate grant is not utilized, then in step 335 multiplexer 220 extracts an amount corresponding to the unused portion of the rate grant from the plurality of buffers 205, 210 and 215 in accordance with the priority order. In one embodiment, multiplexer 220 will attempt to extract as many of the unused bits from each of the buffers according to the priority order. For example, suppose the priority order indicate the traffic flow priority, from highest to lowest, as follows: VoIP, VT and FTP. If 100 bits of the total rate grant are unused, then multiplexer will first attempt to extract 100 bits from the VoIP buffer since it is associated with the highest priority traffic flow. If it was unable to extract all 100 bits from the VoIP buffer, multiplexer 220 would then attempt to extract an amount up to the remaining unused bits (i.e., 100 bits minus bits extracted from VoIP buffer in step 335) from the VT buffer, which is associated with the next highest priority traffic flow. If there are any remaining unused bits, multiplexer 220 would attempt to extract an amount up to the remaining unused bits from the FTP buffer.

From step 335, or if it is determined in step 330 that the total rate grant is being utilized, flowchart 300 continues to step 340 where the data extracted by multiplexer 220 are multiplexed into a MAC packet and transmitted by transmitter 230 using the subcarrier frequencies and modulation scheme indicated in the scheduling grant. In step 345, receiver 250 receives the MAC packet at eNode B 120. In step 350, demultiplexer 255 demultiplexes the MAC packet and places the data in the appropriate buffers 260, 265 and 270.

Although the present invention has been described in considerable detail with reference to certain embodiments, other versions are possible. Therefore, the spirit and scope of the present invention should not be limited to the description of the embodiments contained herein.

1. A method of transmitting data from a plurality of traffic flows comprising the step of:
extracting data from one or more buffers based on a quality of service indicator and a rate grant, wherein the one or more buffers are associated with one or more traffic flows; and
transmitting a data packet comprising the extracted data.

2. The method of claim 1, wherein the step of extracting the data comprises the step of:
partitioning the rate grant into one or more rate grant partitions based on the quality of service indicator.

3. The method of claim 2, wherein the data is extracted from the one or more buffers up to amounts associated with the rate grant partitions.

4. The method of claim 1, wherein the quality of service indicator is an index to a lookup table that maps the index to a manner of partitioning the rate grant.

5. A method of transmitting data from a plurality of traffic flows comprising the step of:
extracting data from one or more buffers based on a quality of service indicator, a rate grant and a priority order, wherein the one or more buffers are associated with one or more traffic flows; and
transmitting a data packet comprising the extracted data.

6. The method of claim 5, wherein the step of extracting the data comprises the step of:
partitioning the rate grant into one or more rate grant partitions based on the quality of service indicator.

7. The method of claim 6, wherein the step of extracting the data comprises the step of:
extracting a first set of data from the one or more buffers up to amounts associated with the rate grant partitions.

8. The method of claim 7, wherein the step of extracting the data comprises the step of:
determining whether a total amount of data in the first set of data is less than the rate grant.

9. The method of claim 8, wherein the step of extracting the data comprises the step of:
extracting a second set of data based on the priority order if the total amount of data in the first set of data is less than the rate grant.

10. The method of claim 9, wherein a total amount of data in the second set of data is not more than a difference between the rate grant and the total amount of data in the first set.

11. The method of claim 1, wherein the quality of service indicator is an index to a lookup table that maps the index to a manner of partitioning the rate grant.

12. A method of transmitting data from a plurality of traffic flows comprising the step of:
transmitting a quality of service indicator and a rate grant; and
receiving a data packet comprising data extracted based on the quality of service indicator and the rate grant.

13. The method of claim 12, wherein the quality of service indicator is an index to a lookup table that maps the index to a manner of partitioning the rate grant.

14. A method of transmitting data from a plurality of traffic flows comprising the step of:
transmitting a quality of service indicator, a rate grant and a priority order; and
receiving a data packet comprising data extracted based on the quality of service indicator, the rate grant and the priority order.

15. The method of claim 14, wherein the quality of service indicator is an index to a lookup table that maps the index to a manner of partitioning the rate grant.
